(19) United States
(12) Patent Application Publication
(10) Pub. No.: US 2011/0114801 A1
(43) Pub. Date: May 19, 2011

(54) CABLE SUPPORT DEVICE

(75) Inventor: Bruno Ehmann, Mogglingen (DE)

(73) Assignee: icotek project GmbH & Co. KG, Mogglingen (DE)

(21) Appl. No.: 12/902,407

(22) Filed: Oct. 12, 2010

(30) Foreign Application Priority Data
Nov. 12, 2009 (DE) 10 2009 060 988.1

(51) Int. Cl. F16L 3/22

(52) U.S. Cl. 248/68.1

(57) ABSTRACT

The invention concerns a cable supporting unit with the following components or features:
an elastically deformable cable holder, including a number of membranes, which can be penetrated by cables;
in operating condition, the cable holder is provided with cables, which are captive-mounted in the penetrated membranes;
with at least two frame portions, which are arranged slack to one another before operation and are connected fixedly to each other in operating condition;
at least one frame portion presents a reception opening for accommodating the cable holder;
in operating condition, the cable holder assembly is stretched out fixedly and tightly in the reception opening;
before operation, the cable holder assembly can be inserted in a drawer-like manner into the reception opening and once inserted is captive-mounted in non-positive engagement.

The invention concerns a cable supporting unit for carrying cables. To do so, the individual cable is run through the cable supporting unit. It is known to lay the cables in the next step in so-called strain reliefs. These are elastic bodies which include a bore for accommodating the cable. The strain reliefs are moreover slitted, so that they can be open for laying the cables. A known cable supporting unit moreover includes two frame portions. At least one of the frame portions presents a reception opening for laying the strain reliefs provided with cables. See EP 1 236 256 B.

Document WO 99/06747A describes a cable supporting unit which includes two parts. The parts contain matching semi-circular recesses, which once assembled form a full circle for accommodating a cylindrical strain relief. This type of cable supporting unit has the shortcoming that when assembling a cable, the strain relief is only inserted in one of both semi-circular recesses. In such position, the strain relief is not reliably connected with the recess. If the installer wants further semi-circular recesses with strain reliefs and also to lay in cables sheathed with said strain reliefs, there is the risk that the strain relief laid in previously may drop out of the semi-circular recess.

Document 40 20 180 C describes a cable supporting unit wherein ring-shaped sealing elements are provided.

Document DE 36 19 183 concerns a cable bushing for a fuse and distribution box for motor vehicles. To do so, a fixed receptacle is already permanently mounted on a vehicle bodywork. The receptacle includes upwardly open recesses. Strain reliefs provided with cables are laid in from the top in said recesses and then dosed with a lid.

Document DE 199 59 185 A1 describes a cable supporting unit which includes all the features of the preamble of claim 1. Other cable supporting units have been disclosed in documents DE 21 09 548 A, DE 10 2008 028 278 A1, US 2003/0178787 A1 and DE 10 2007 060 100 A1. The latter document discloses cable holders which are secured to a frame once the cables have been inserted into the cable holder.

In all previously known embodiment variations, the fastening of the cables in the cable supporting unit is problematic, since labour intensive, especially as regards the production as well as when fastening the cables.

The object of the invention is then to provide a cable supporting unit which can be manufactured easily, quickly and reliably. In particular, the fastening of the cables in der cable supporting unit should be an easy, straightforward and reliable operation. In particular, the cable supporting unit should be easy to produce off site. It should hence be possible to produce the complete cable supporting unit or sections hereof on different locations and then to assemble the various parts on another, central location.

This object is met by a cable supporting unit according to claim 1.

The inventor has built his research on well-known elements. He uses a cable holder, which consists of an elastically deformable material and includes a number of membranes, which can be penetrated by cables. The cable holder is generally plate-like.

There are other elements such as frame portions, which are arranged slack to one another before operation and are connected fixedly to each other in operating condition. At least one frame portion presents a reception opening for accommodating the cable holder. Moreover, the cable holder and the frame portion(s) are designed in such a way that the cable holder can be inserted into the reception opening and once inserted is captive-mounted in non-positive engagement.

The major advantage of the invention can be described as follows:

First of all, the cable holder can be provided with cables. To do so, every cable is maintained reliably and captive-mounted in the penetrated, elastic membrane. The various cables can be laid in the cable holder in any location, away from the centre. The cable holder assemblies may then be sent to the centre, without running the risk of the cables dropping out of the cable holder.

The next assembly next, namely filling the frame portions with the cable holder assemblies, can be performed at any remote location. Also, after this second assembly step, the complete construction unit, including the cable holder assemblies as well as the frame portions provided with the cable holders, can be safely shipped; there is no risk of cables becoming loose.

The invention thus enables to use different assembly operations, spatially remote from one another, so that local advantages of different operations can be used to the full.

The invention is described below with reference to the drawing. The following details are shown:

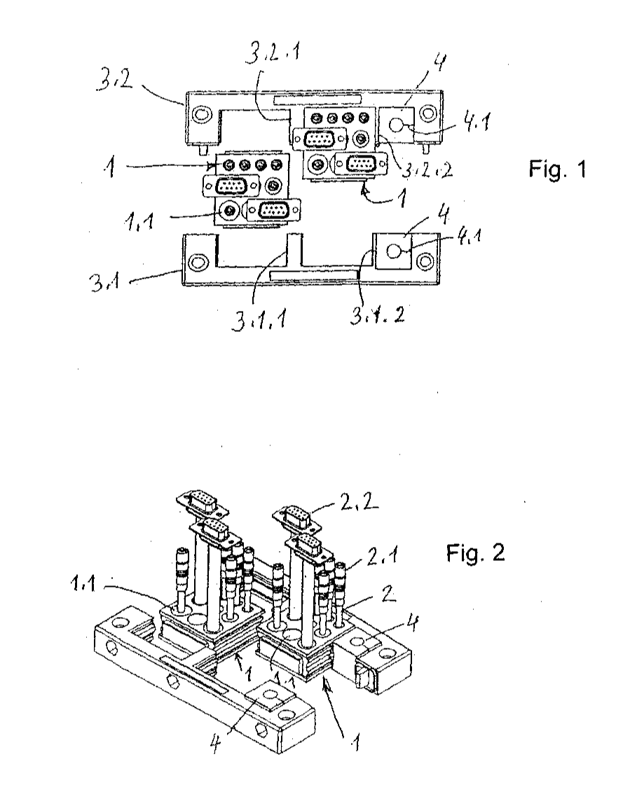

FIG. 1 is an elevation view of a first embodiment of a cable supporting unit with cables, partially mounted.

FIG. 2 shows the object of FIG. 1 in perspective view.

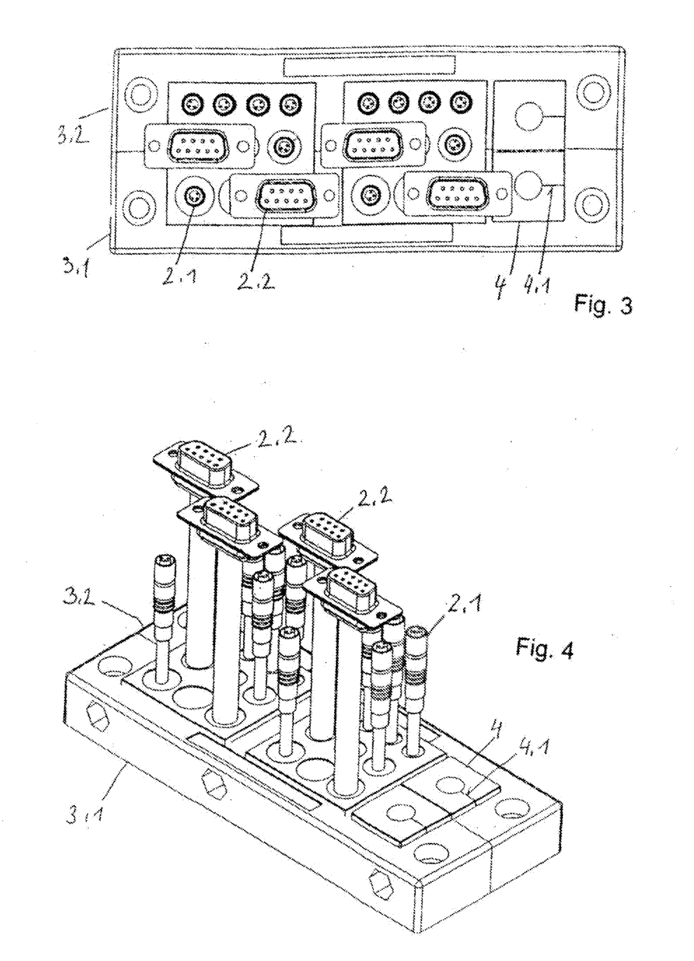

FIG. 3 is an elevation view of a second embodiment of a cable supporting unit once assembled.

FIG. 4 shows the object of FIG. 3 in elevation view.

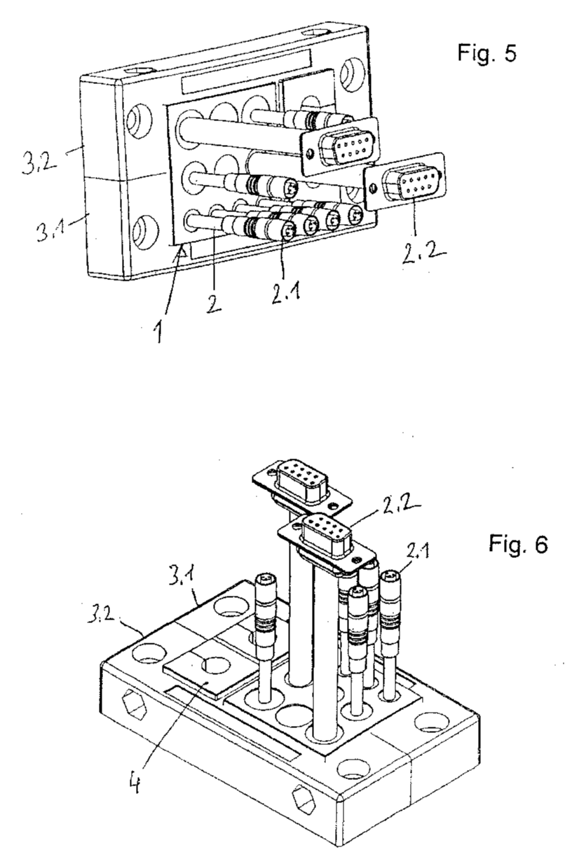

FIG. 5 is a perspective view of a third embodiment of an assembled cable supporting unit.

FIG. 6 shows the object of FIG. 5 also in perspective view, however rotated with respect to FIG. 5.

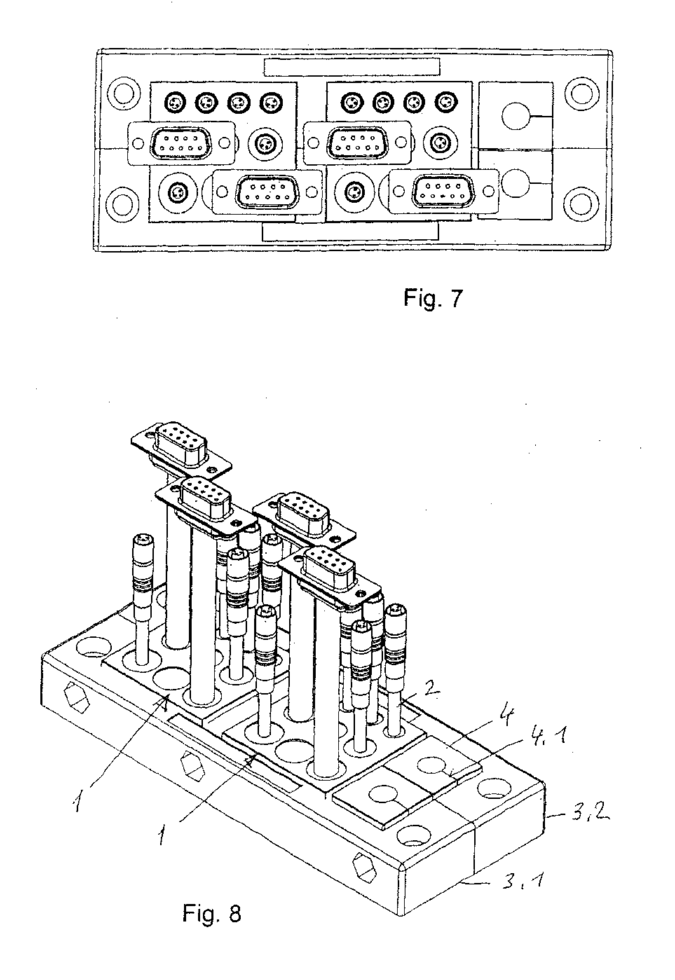

FIG. 7 is an elevatinn view of a fourth embodiment of a cable supporting unit once assembled.

FIG. 8 shows the object of FIG. 7 in perspective view.

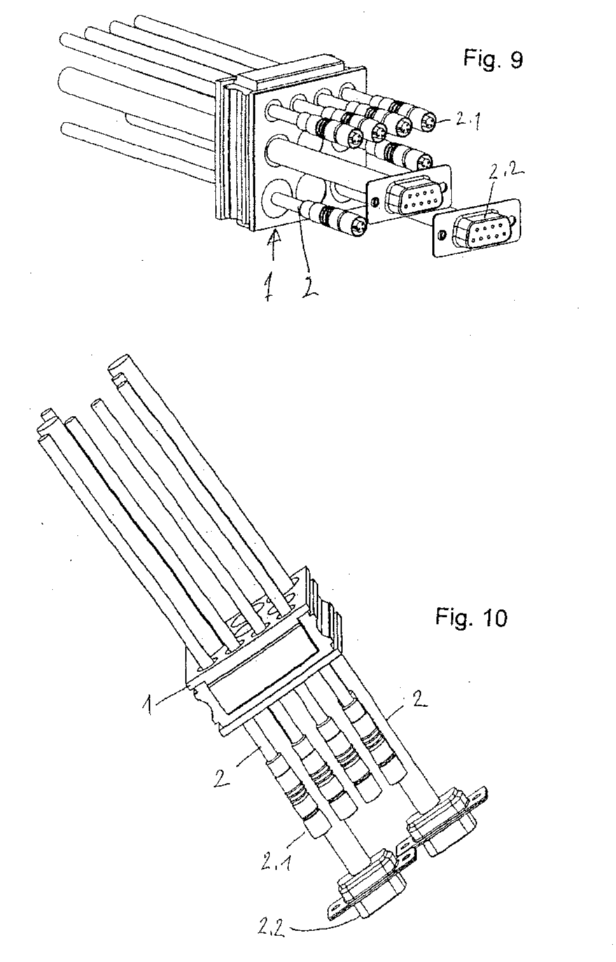

FIGS. 9 and 10 are perspective views of a cable holder provided with cables.

FIGS. 1 and 2 clearly show two cable holders 1. The cable holders are plate-like. In an elevation view, they are square or approximately square.

Every cable holder includes a number of membranes 1.1. Some of the membrane 1.1 are fitted with cables 2. The cables 2 are run through the membrane 1.1, so that they also appear on the lower side of the corresponding cable holder 1, not visible here. The cables 2 have round connectors 2.1 or rectangular connectors 2.2.

Besides, the frame portions 3.1, 3.2 are clearly visible. Every frame portion includes strips—see the strips 3.1A, 3.1.2 as well as 3.2.1, 3.2.2. The frame portions 3.1 and 3.2 exhibit reception openings through the strips. The cable holders 1 can be inserted into said elements in a drawer-like manner. At least one of both components—cable holder 1 and frame portion 3.1 or 3.2—consists of rubber elastic material. Generally, cable holder 1 consists of such a material, while frame portion 3.1 or 3.2 consists of metal or synthetic material. Once inserted, the cable holders 1 are maintained reliably and captive-mounted by means of a clamping effect in the corresponding reception opening.

The cables 2 are also maintained reliably into the cable holders 1 after having penetrated the membrane 1.1. Consequently, they cannot fall out, even during transport.

The cable holders 1 fitted with cables 2 hence constitute a stand-alone construction unit. The cable supporting unit is assembled completely once the frame portions 3.1, 3.2 have been installed, that is to say by insertion in their reception opening and by closing the frame portions 3.1, 3.2.

The first embodiment according to FIGS. 1 and 2 presents a particularity. Each of the frame portions 3.1 and 3.2 contains a grommet 4. The latter consists of rubber elastic or similar material. It is designed in such a way that it fits in a reception opening, formed of a corresponding strip 3.1.2 or 3.2.2 and the corresponding frame portion 3.1 or 3.2. The gronunet includes a bore. Their clear width is identical to or slightly smaller than, the diameter of a cable 2 provided to that effect (not represented). The grommet 4 includes a slit 4.1. This enables to widen the grommet and to insert the cable into the bore.

The grommets 4 can also be inserted in a drawer-like manner into the corresponding reception opening and are captive-mounted once inserted.

It should be noted that this operation does not require any strip. It can thus be envisioned to insert two or several cable holders 1 into a single reception opening. Neighbouring cable holders hence lie close to one another and tight against one another, so that they are clamped in the reception opening, again captive-mounted. The same obviously goes also for the number of grommets inside a reception opening.

The second embodiment according to FIGS. 3 and 4 shows the cable supporting unit once assembled completely.

The third embodiment according to FIGS. 5 and 6 only includes a single cable holder 1, but again two grommets 4.

The fourth embodiment includes two cable holders 1 and two grommets 4.

FIGS. 9 and 10 show a single cable holder 1. The latter is fitted with several cables 2, some with a round connector 2.1 and two with a rectangular connector 2.2.

As FIGS. 1 and 9 clearly show the cable holders 1 exhibit by at least two narrow sides, grooves which enable to maintain the cable holders 1 inserted in positive engagement. The same goes for the grommets 4.

The invention can be applied stationary as well as mobile, consequently for instance for control cabinets as well as for motor vehicle.

### LIST OF REFERENCE NUMERALS

1 Cable holder

1.1 Membrane

2 Cable

2.1 Round cable connector

2.2 Angular cable connector

3.1 Frame portion

3.2 Frame portion

3.1.1 Strip

3.1.2 Strip

3.2.1 Strip

3.2.2 Strip

4 Grommet

4.1 Slit

1. A cable supporting unit with the following components or features:
1.1 at least one elastically deformable cable holder (1), including a number of membranes (1.1), which can be penetrated by cables (2);
1.2 in operating condition, the cable holder (1) is provided with cables (2);
1.3 with at least two frame portions (3.1, 3.2), which are arranged slack to one another before operation and are connected fixedly to each other in operating condition;
1.4 at least one frame portion (3.1, 3.2) presents a reception opening for accommodating the cable holder (1);
1.5 in operating condition, the cable holder assembly (1) is stretched out fixedly and tightly in the reception opening;
1.6 before operation, the cable holder assembly (1) can be inserted in a drawer-like manner into the reception opening and once inserted is captive-mounted in non-positive engagement;
characterised by the following features:
1.7 the cable holder (1) presents a number of membranes (1.1), which can be penetrated by cables (2) and the cables (2) once they have penetrated into the membranes (1.1) are captive-mounted.

2. A cable supporting unit according to claim 1, characterised in that the frame portions (3.1, 3.2) contain grommets (4) for strain relief.

3. A cable supporting unit according to one of the claims 1 to 3, characterised in that the frame portions (3.1. 3.2) include strips (3.1.1, 3.2.1, 3.1.2, 3.2.2) for providing the reception openings.

4. A cable supporting unit according to one of the claims 1 to 3, characterised in that both frame portions (3.1, 3.2) include reception openings.

5. able supporting unit according to one of the claims 1 to 3, characterised in that only one frame portion presents reception openings and the other frame portion is designed as a rectilinear bar.
